(19) United States
(12) Patent Application Publication
(10) Pub. No.: US 2014/0125155 A1
(43) Pub. Date: May 8, 2014

(54) TOROIDAL MOTOR DESIGN HAVING BACK EMF REDUCTION

(71) Applicant: CONVERGENT POWER, INC., Los Angeles, CA (US)

(72) Inventor: James F. Murray, Oklahoma City, OK (US)

(73) Assignee: CONVERGENT POWER, INC., Los Angeles, CA (US)

(21) Appl. No.: 13/669,360

(22) Filed: Nov. 5, 2012

(51) Int. Cl. H02K 37/04

(52) U.S. Cl. 310/46

(57) ABSTRACT

Some embodiments of the disclosed invention provide a toroidal DC motor that reduces Back EMF and, therefore, minimizes the degradation of source potential. In addition, embodiments of the disclosed invention provide a motor that provides constant torque at constant current irrespective of the speed of the rotor. Likewise, some embodiments of the disclosed inventions provide output horsepower that increases with the rotational speed of the rotor.

### CROSS REFERENCE TO RELATED APPLICATIONS

This application is related to the concurrently filed application Ser. No. ______, titled “Controller For Toroidal Motor Having Back EMF Reduction,” which is incorporated entirely herein by reference.

### FIELD OF THE INVENTION

The disclosed inventions relate to the field of direct current (“DC”) electric motors, and more particularly to DC motors having a toroidal stator winding and externally driven commutation to drive a rotor by interaction with a rotating magnetic field.

### BACKGROUND

As described in this inventor's prior patents, conventional geometry motors are affected by Speed Voltage Back EMF that is parasitic in nature and, among other things, degrades the source potential supplied to the motor. This inventor has implemented novel geometries to reduce Speed Voltage Back EMF, such as those disclosed in co-pending application Ser. No. 13/562,233, titled “Multi-Pole Switched Reluctance D.C. Motor with a Constant Air Gap and Recovery of Inductive Field Energy,” which is hereby incorporated by reference in its entirety.

In most conventional DC motors, the energizing current to the motor is delivered via some type of commutation in communication with the motor coils. Typically, commutation may be accomplished by a mechanical commutator (e.g., commutator bars and carbon brushes), or by electronic commutation (e.g., an electronically controlled switching circuit). In most existing devices the commutator operates in conjunction with the rotor, either by being physically coupled to the rotor by a common shaft (e.g., mechanical commutation), or electronically by relying on information relating to the position of the rotor (e.g., electronic commutation).

Many drawbacks and limitations are present in existing DC motors. In addition to the above-mentioned degradation of source potential, existing designs are inconvenient for applications desiring a constant torque output with an unvarying input current. Likewise, existing designs do not lend themselves easily to creating an output horsepower that increases with the rotational speed of the rotor. Other drawbacks of traditional designs also exist.

### SUMMARY

One advantage of the presently disclosed system and method is that it addresses the drawbacks of existing systems.

Accordingly, another advantage of some embodiments of the disclosed invention is that they provide a toroidal DC motor that reduces Back EMF and, therefore, minimizes the degradation of source potential. In addition, embodiments of the disclosed invention provide a motor that provides constant torque at constant current irrespective of the speed of the rotor. Likewise, some embodiments of the disclosed inventions provide output horsepower that increases with the rotational speed of the rotor. Other advantages and features of the disclosed invention also exist and may be apparent to those of skill in the art.

Exemplary non-limiting embodiments are disclosed herein, however, it should be appreciated that other appropriate embodiments are encompassed by the present disclosure, the possible variations being too numerous to illustrate. It is understood that one skilled in the art would recognize that other potential arrangements are capable of supporting the principles disclosed herein. Other aspects and advantages of the presently disclosed systems and methods will now be discussed with reference to the drawings.

### BRIEF DESCRIPTION OF THE DRAWINGS

FIG. 1 is an overview of a DC toroid motor in accordance with some embodiments of the disclosed inventions.

FIG. 2 shows a close-up view of a driven commutator 30 in accordance with some embodiments of the disclosed invention.

FIG. 3 shows a close-up view of some embodiments of the rotor/stator assembly 40.

FIG. 4 is a close-up view of toroidal stator 44 with the cover removed.

FIG. 5 shows a series connection scheme for stator coils 50 in accordance with some embodiments of the invention.

FIG. 6 shows a schematic diagram of an embodiment of a toroid stator and rotor assembly 40 and a representation of the rotating magnetic flux 80 and Dead Zones 70.

FIG. 7 shows a perspective view of a rotor/stator assembly 40 in accordance with some embodiments of the invention.

FIG. 8 illustrates a side view of a commutator housing configured for parallel connection of stator coils 50 in accordance with some embodiments.

FIG. 9 shows a perspective view of a rotary switch for use with the brush holder ring 302 of FIG. 8 and utilized in embodiments of parallel coil configuration.

FIG. 10 shows a side view of an embodiment of a brush holder ring 302 of FIG. 8 and also showing the conductors 322 which are to be connected to power the coils 50.

FIG. 11 shows a perspective view of another embodiment of a rotor.

### DETAILED DESCRIPTION

In the following detailed description, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

The operation of a DC Motor of standard design requires that sets of magnetic field producing coils be electro-mechanically, or electronically switched, so as to secure an output torque and continuous rotary motion. This is typically achieved by timing the switching of the coils, such that the coil windings spend a maximum amount of time beneath the magnetic poles of the motor such that the electromagnetic force (F) described by the Lenz force relationship,

F=BlI

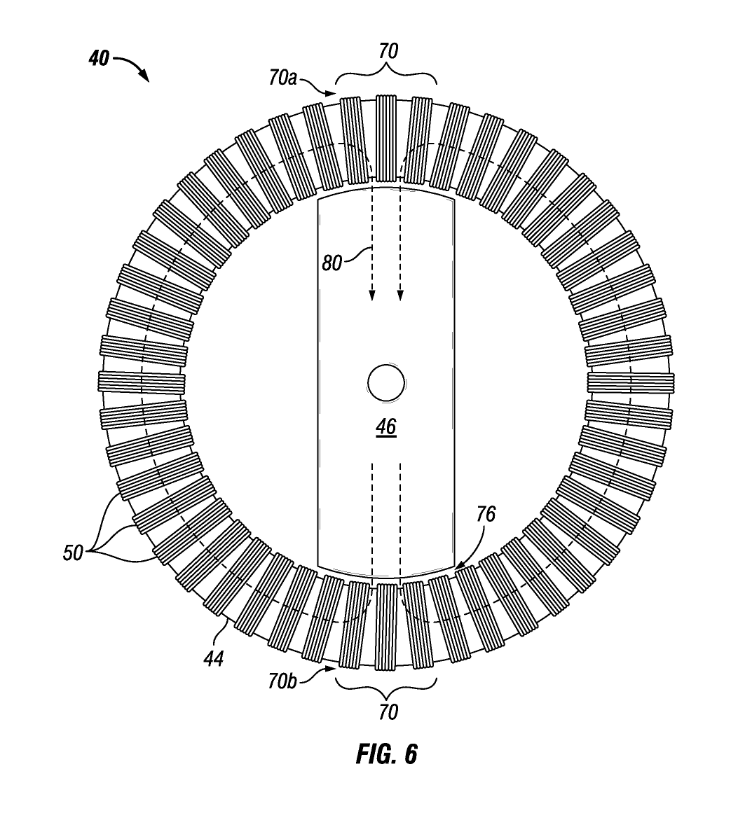

(where B is the magnetic field, l is the length of the conductor, and I is the current) can be fully exploited. However in the invention herein disclosed, two opposing magnetic fields are created within the toroidal windings of the stator, and come together at two points (i.e., 180 mechanical degrees apart) where they exit the confines of the stator iron, traverse the air gap, and enter the rotor structure which is positioned across a diameter of the toroid. Accordingly, the reluctance forces associated with this rotor structure will cause the rotor to align itself with the flux lines, producing a torque, and providing a closed path for the flux to travel through the rotor, cross the air gap on the other side, and return to the stator, thus, allowing each flux line to return to its associated coil group. This is discussed in more detail with reference to FIG. 6 below. Thus, a very large value of restoring torque may exist within the motor, rotor, and drive shaft whether rotation ensues or not. Rotation is a secondary feature of this arrangement, and is determined by the switching frequency of the windings. Therefore, when rotation is desired, a switching sequence is initiated which turns off and isolates one coil in one coil group, while simultaneously turning on one coil in the other complementary coil group. This action will advance the position of the rotor by 360/n degrees, where n is the total number of coils arranged around the periphery of the toroidal stator. The switching sequence is repeated for the next adjacent set of coils in each group and rotation may be sustained at a speed related to the rate of switching.

The areas where the rotating flux field dynamically interacts with the windings are at the two positions where the flux exits out of the stator and enters the rotor, and exists out of the rotor and enters the stator. Therefore, depending upon the arc length required by the physical dimensions of the rotor, a certain number of windings are electronically eliminated from the overall circuit within these two regions, thereby providing a “Dead Zone,” or an isolated segment at each end of the rotor's immediate position, thereby insuring that speed-related Back EMF will be kept to an absolute minimum.

Therefore, a motor operating in accordance with this scheme, will sustain a rotating field of flux 80, and a rotating Dead Zone 70, which possess the same angular velocity, but not necessarily the same phase relationship. Depending upon the load applied to the motor, the Dead Zone 70 may be advanced or retarded, or broadened or narrowed, with respect to the rotor's position, in order to minimize any flux coupling between the rotating field and the DC windings. This control feature may be a function of some embodiments of the electronic controller 90, and is disclosed in greater detail in concurrently filed, related application Ser. No. ______, titled “Controller For Toroidal Motor Having Back EMF Reduction.”

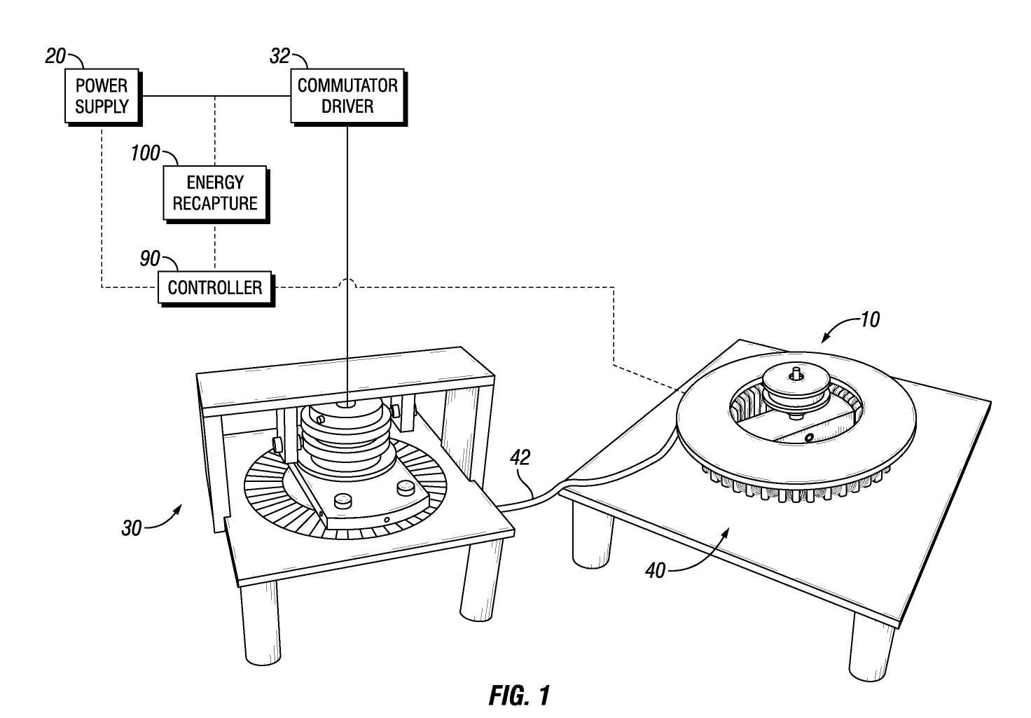

FIG. 1 is an overview of a DC toroid motor system in accordance with some embodiments of the disclosed inventions. As shown, some embodiments may comprise a DC toroid motor 10 further comprising an appropriate power supply 20. Of course, the particular power supply 20 may vary in accordance with factors such as the intended use of the motor 10, the environment motor 10 is intended to operate in, the desired electric inputs, the desired torque outputs, the desired RPM, or the like.

Some embodiments of motor 10 may comprise a commutator 30 assembly. As shown, some embodiments may comprise a commutator 30 that is located apart from the rotor/stator assembly 40. Further, in embodiments where commutator 30 comprises an electro-mechanical device, a powered driver 32 may also be included. Powered driver 32 may comprise any suitable motor, or other prime mover, capable of imparting the desired rotational motion to commutator 30.

Some embodiments also may comprise a number of conductors 42 in electrical communication with stator coils and commutator 30 contacts 38. For clarity, the figures only illustrate a single conductor 42, but, of course, as many conductors 42 as desired may be implemented. In addition, any suitable connection mechanisms may also be implemented, such as ribbon cables, multi-conductor cables, modular connectors, connection busses, or the like. Likewise, any suitable conductors 42 are possible and may vary with the intended use, power, speed, number of coils, or environment considerations. Optional controller 90 and optional energy recapture 100 are discussed below and may also be provided in some embodiments.

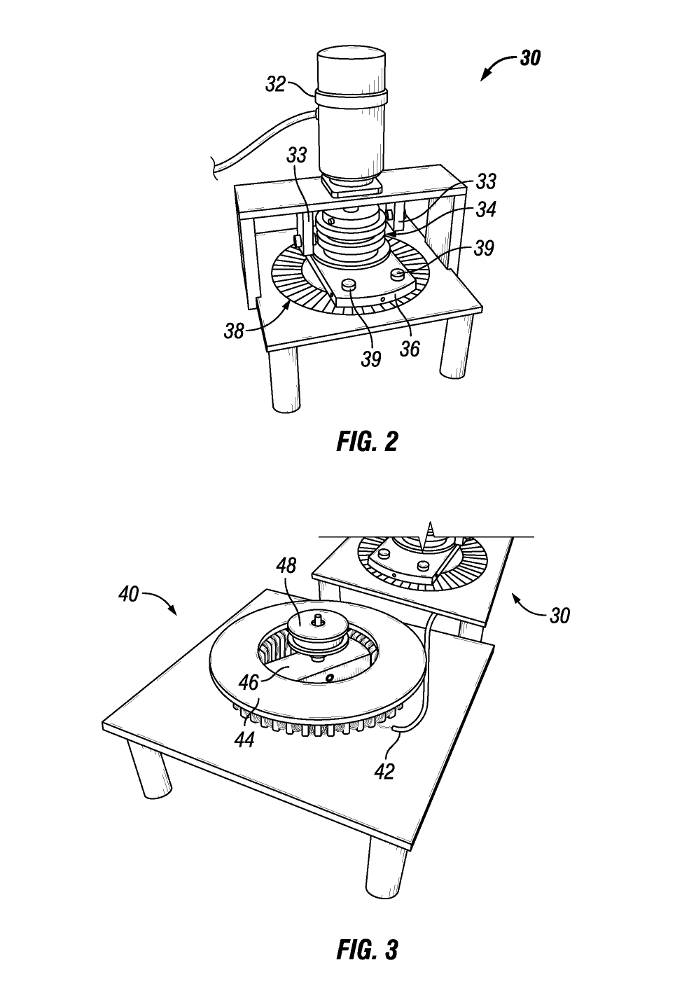

FIG. 2 shows a close-up view of commutator 30 in accordance with some embodiments of the disclosed invention. As shown, embodiments of commutator 30 may include a slidable contact by which energizing power from power supply 20 may be fed to the stator coils of rotor/stator assembly 40. For example, embodiments may comprise a slidable contact such as slip rings 34 which receive power from power supply 20 via input power brushes 33. As shown in FIG. 2, two input power brushes 33 are in slidable, electrical contact with two slip rings 34 to accommodate the two poles of DC current (e.g., positive and ground, or positive and negative). Other configurations are also possible.

Embodiments of commutator 30 also may comprise a rotating assembly 36. Rotating assembly 36 may be driven by commutator driver 32 (e.g., via a common shaft, coupled shafts, gearing, pulleys, or the like) causing the rotating assembly 36 to slide over contacts 38. Embodiments of rotating assembly 36 may also comprise one or more switching brushes 39 per rotor pole that facilitate the transfer of input power from input power brushes 33 and slip rings 34 to contacts 38, and then to the stator coils via conductors 42. As discussed in more detail below, the rotating assembly 36, in association with its brushes, will create two Dead Zones 70 which rotate in sync with the rotor 46, thus, nullifying the interaction between the rotating flux field and the windings located in the Dead Zones 70.

FIG. 3 shows a close-up view of some embodiments of the rotor/stator assembly 40. As shown, conductors 42 carry input power from the contacts 38 to the toroidal stator 44 and may be connected to the stator coils in any suitable configuration as discussed in more detail below. As shown, toroidal stator 44 is generally annular in shape and arranged to allow rotor 46 to rotate within the center space of the toroid.

As shown in FIG. 3 some embodiments of rotor 46 may comprise an un-excited (e.g., coil-less) rotor 46. For some embodiments rotor 46 may be generally rectangular with ends shaped to conform to a curvature that generally matches the curvature of the inner circle of the toroid stator 44 to ensure a constant air gap, and allow free rotation. Other embodiments may include coils (not shown) on rotor 46 in order to, among other things, provide a mechanism for increasing motor 10 torque output.

Other shapes and configurations for rotor 46 are also possible. For example, rotor 46 may comprise a disc of varying magnetic permeability. A portion of such a disc may include a relatively high permeability material that provides a preferential flux path through the rotor 46. Other shapes and configurations for rotor 46 are also possible.

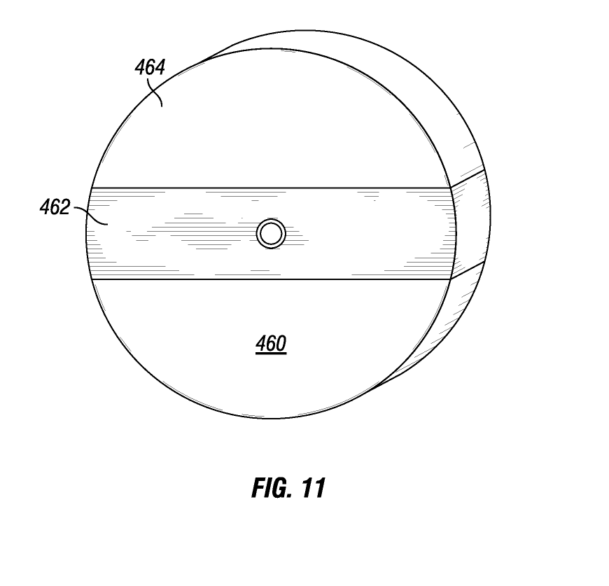

FIG. 11 is an illustration of an embodiment of such a disc-shaped rotor 460. As shown, a magnetically permeable path 462 is provided in a lower permeability material 464. Of course, other shapes, paths, and configurations are also possible.

In some embodiments, it may be preferable to couple motor 10 with other machines, instruments, or devices, therefore, output coupler 48 may be provided on a shaft coupled to rotor 46. Output coupler 48 may comprise one or more pulleys, gears, shafts, or other couplers.

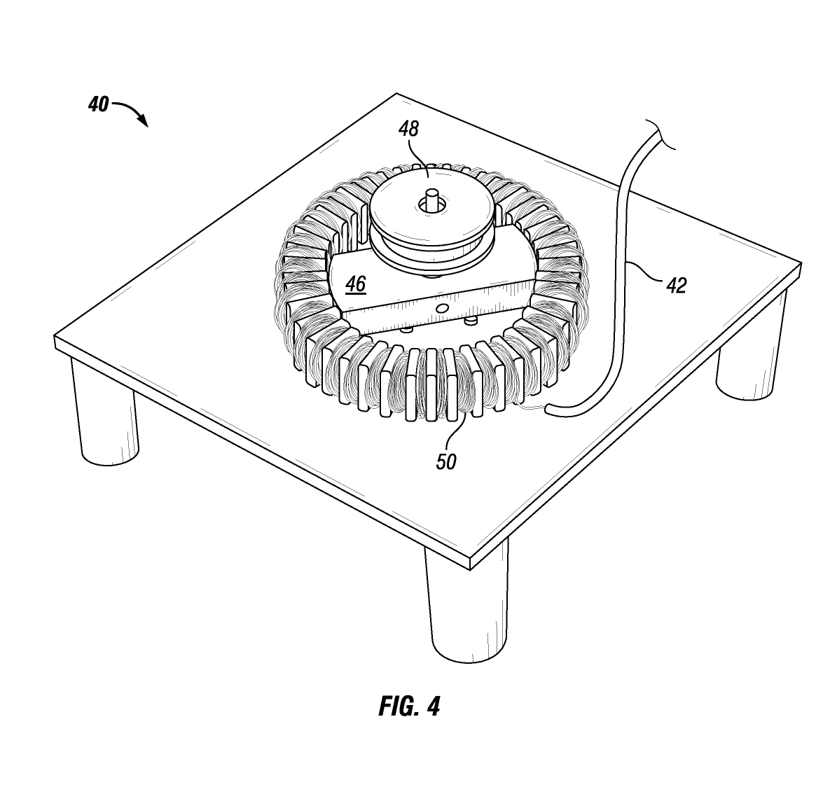

FIG. 4 is a close-up view of toroidal stator 44 with the cover (e.g., end bell) removed. As shown, stator 44 may comprise a number of toroidally wound stator coils 50. For some embodiments, stator coils 50 may comprise a number of individually wound coils.

A variety of connection schemes for stator coils are possible. FIG. 4 illustrates a series connection for stator coils 50 in that each coil is connected to the next in a series fashion. In some embodiments, a series connection may be accomplished by connecting commutator contacts 38 located 180 mechanical degrees apart (i.e., opposite sides of a diameter) with opposite switching brushes 39 on the rotating assembly 36.

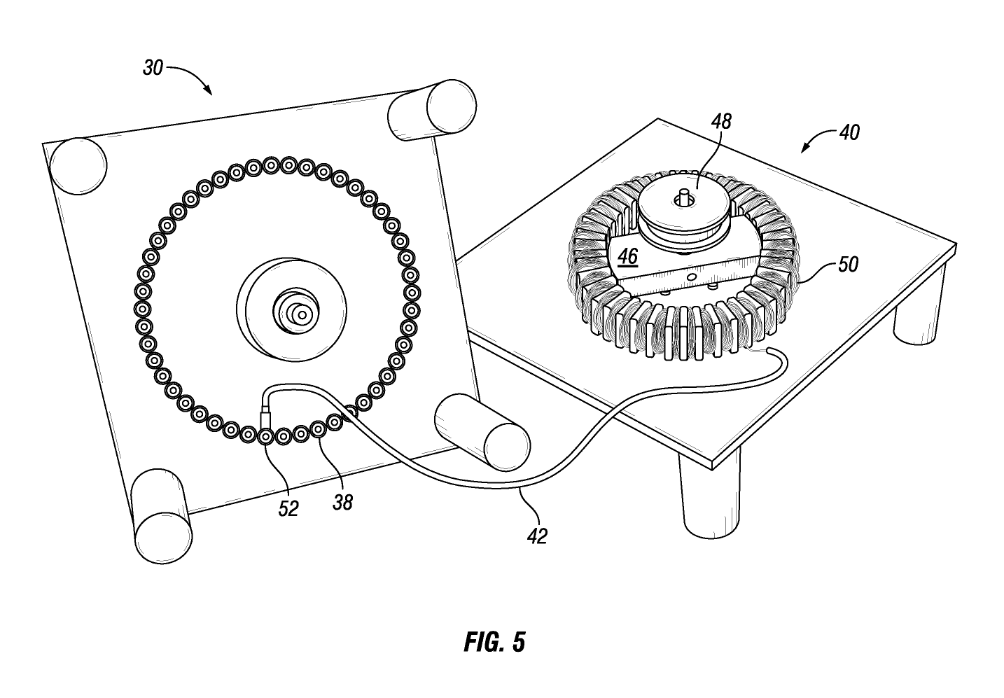

FIG. 5 shows a series connection scheme for stator coils 50 in accordance with some embodiments of the invention. As shown in FIG. 5 the opposite side of contacts 38 may comprise one or more terminals 52 that are in electrical communication with conductors 42. As also shown, for a series connection some embodiments may include electrical connections between terminals 52 on half of stator 44 being connected to half of the coils 50 and the remaining half of terminals 52 being connected to the other half of the coils 50 on stator 44, but varying the connection as the contacts 38 slide, thus, creating a mechanically driven rotating magnetic field. This, in conjunction with the connection of switching brushes 39, which are in turn connected to opposite poles of the input DC power, enables the creation of a rotating stator magnetic field having two paths with each path being of opposing magnetic polarity (e.g., North and South).

The operation of some embodiments demands that motor-driven commutator assembly 32, rotates the rotating assembly 36, such that the two sets of switching brushes 39 will make and break contact with the commutator contacts 38, and thereby switch the appropriate stator coils 50 in and out of the supply 20 circuit. The switching is so performed that no current is allowed to flow through the coil 50 windings which lie between each respective pair of brushes 39, thus, isolating those coils 50. This selective form of switching, then creates a series of “inactive and isolated coils” which constitute two Dead Zones 70 located 180 mechanical degrees apart on the stator 44, and rotate in synchronism with the rotor 46. These traveling Dead Zones 70, then, represent windows for the flux 80 to pass through with minimal, if any, inducing of a Back EMF Voltage, or a Back Torque, either of which could reduce motor 10 performance.

As with any magnetic field, the flux lines 80 created by the energized coil 50 windings will travel from one pole to the other (e.g., North to South). Rotor 46, which for some embodiments may comprise steel or some other magnetically responsive material, provides a preferred path for the flux lines to travel through, and complete the magnetic circuit, but in so doing, will align the rotor 46 so that the end faces of the rotor line up with the Dead Zone 70 created in the coil 50 windings. This is illustrated in FIG. 6 which shows a schematic diagram of a toroid stator and rotor assembly 40 and a representation of the rotating magnetic flux lines 80 and Dead Zones 70. As shown, rotor 46 may be generally rectangular with ends shaped to conform to a curvature that generally matches the curvature of the inner circle of the toroid stator 44 to ensure a constant air gap 76, and allow free rotation. At the instant depicted in FIG. 6, active coils 50 on the “left half” of the toroid stator 44 generate magnetic flux lines 80 that cross air gap 76, enter the rotor 46 through Dead Zone 70a, traverse the rotor 46, and exit the rotor 46 and cross air gap 76 through Dead Zone 70b to complete the magnetic circuit. Likewise, active coils 50 on the “right half” of the toroid stator 44 traverse a corresponding route on the other side of the toroid stator 44.

In the above-described manner, the Back EMF due to rotation of the rotor 46 in the presence of the stator 44 magnetic field is reduced by controlling the characteristics of the rotor 46 and coil 50 interactions. Creation of the Dead Zones 70 insures that no current is present in the adjacent coil 50, and consequently minimal, or no, Back EMF Voltage or magnetic field is generated in that coil 50, when rotor 46 is adjacent to the coil 50.

Such an arrangement creates a motor 10 that delivers constant torque at varying rotor 46 speeds. Furthermore, the torque is adjustable by changing the input current, and, thus, the magnitude of the resultant stator 44 magnetic field. At given current setting the motor 10 output torque will remain relatively constant irrespective of speed. Further, motor 10 output horsepower (HP), can be determined from:

HP=(Torque×speed)/K, where K is constant that depends upon the units used.

It is apparent that for embodiments of motor 10 that the HP increases as RPM increases, and, output torque will stay constant for a given current (and magnetic field strength), thus, horsepower can be varied with the speed of the rotor 46 which is determined by the switching frequency, or by changing the current at a given speed. Other advantages also exist.

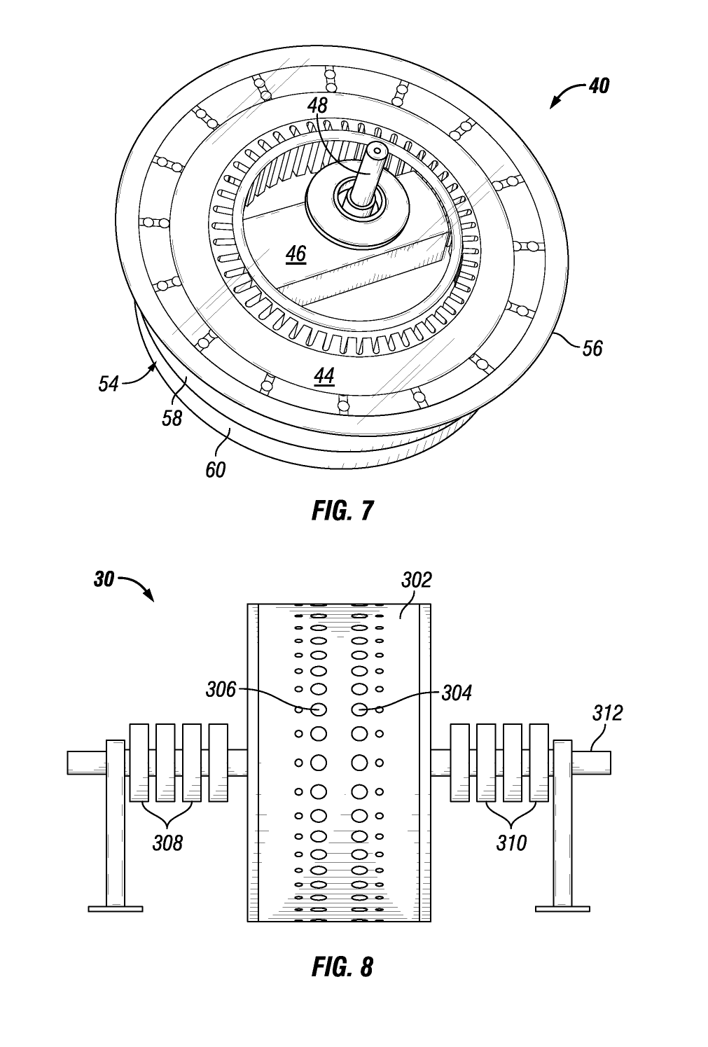

FIG. 7 shows a perspective view of a rotor/stator assembly 40 in accordance with some embodiments of the invention. As shown for this embodiment (with coils 50 removed for clarity), rotor/stator assembly 40 may be housed in an appropriate housing 54. For example, depending upon factors such as the intended environment, the intended use, the cost of materials, the conductive and magnetic properties, and the like, housing 54 may comprise an artificial material (i.e., man-made plastics, resins, polymers, or the like), a natural material (i.e., wood, metal, or the like), or combinations of the same (e.g., alloys, composite materials, etc.).

Furthermore, embodiments of housing 54 may also comprise shapes other than generally cylindrical, or multi-piece housings, again as appropriate with factors including the intended use and environment. For example, FIG. 7 shows an embodiment with a separate end cover 54 (shown as plastic or plexi-glass), a housing ring 58, and a housing base 60. Other configurations are also possible.

FIG. 8 illustrates a side view of a commutator 30 configured for parallel connection of stator coils 50 in accordance with some embodiments. Parallel connection in the present disclosure means that each stator coil 50 is independently connected to a DC power supply (e.g., supply 20) so that it may be independently energized to create a resultant magnetic field. Further, in accordance with the disclosure herein, the magnetic field flux lines 80 (and Dead Zones 70) may be created using two sets of brushes per stator winding (e.g., brush 304 and brush 306) so that at any given time a portion of the stator coils are energize with one polarity (e.g., positive) and the other portion are energized with the opposite polarity (e.g., negative). Likewise, by turning off the power to, and electrically isolating, a specific coil group, a rotating Dead Zone 70 may be created in accordance with the principles outlined herein.

Control of the switching of the various power cycles for the coils 50 may be achieved in any suitable manner. For example, an electronic control circuit may be implemented to give separate, customizable control over the energizing of each coil 50. For example, a controller 90 housing appropriate control circuitry as shown in FIG. 1 may optionally be provided for some embodiments where electro-mechanical commution is undesirable. An exemplary control circuit is disclosed in the concurrently filed co-pending application Ser. No. ______, titled “Controller For Toroidal Motor Having Back EMF Reduction,” which is hereby incorporated by reference in its entirety.

As shown in FIG. 8, some embodiments may comprise a brush holder ring 302 with active brushes (e.g., 304 and 306) for providing the appropriate polarity of current in each coil 50. Likewise, four slip-rings, or other slidable contacts 308 and 310 are provided (in pairs of two) in order to provide input power to the active brushes and to harvest recaptured power. A shaft 312 may be provided to turn the slidable contacts 308, 310, as well as the mating conductor (not visible in FIG. 8) for the brushes 304, 306.

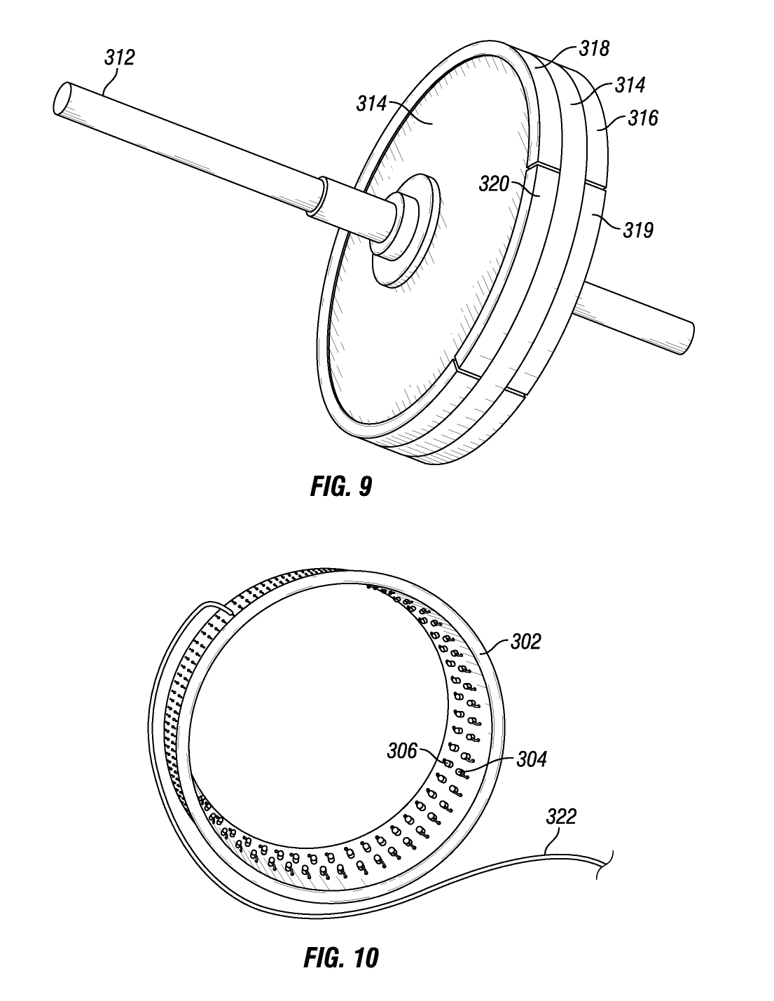

FIG. 9 shows a perspective view of a rotating switch for use with the brush holder ring 302 of FIG. 8. As shown, a non-conducting disk or wheel 314 may be provided as support to a number of conducting ring segments 316, 318, 319 and 320. While four rings (316, 318, 319, 320) are shown in FIG. 9, more could be implemented for embodiments that require more than two poles or additional pairs of polarities of input current. Ring 316 and 318 mate with the brushes 304, 306 in brush holder ring 302 and complete the electrical contact to supply input power to the coils 50.

For some embodiments, rings 316 and 318 may be formed into additional segments as indicated at 319, 320 so that materials of different conductivity can be inserted to add additional control over the energizing of the coils 50. For example, non-conducting segments could be used to turn off brushes 304, 306 and create a Dead Zone 70 in the magnetic field of the coils 50. Other configurations are also possible.

FIG. 10 shows a side view of a brush holder ring 302 of FIG. 8 and also shows the conductors 322 that power the coils 50. For the embodiment shown, conductors 322 may comprise two separate conductors (for each independently powered coil 50 of the toroidal stator 44). Of course, other configurations are also possible.

For some embodiments, parallel configuration of the toroidal stator 44 enables fine tuning and customization of the resultant magnetic field, the Dead Zones 70, and the relative motion of both. In such a manner, it is possible to customize or adapt the motor 10 operative characteristics to suit the intended use, environment, or other parameters. Such control parameters may employ high speed adjustments made by micro-processors imbedded within the electronic control circuitry of controller 90.

The torque and speed characteristics of the motor disclosed here-in are quite straight forward. Because there is little or no Back EMF, the torque is proportional to the applied current regardless of the angular speed. The RPM is dependent upon the effectiveness of the switching frequency, which controls the movement from one coil 50 set to the next. Accordingly, the inductive reactance of the individual coil 50 windings become a limiting factor where speed is concerned, as said reactance will impede or limit the rise time of the magnetic field for a given voltage selection. However, this impedance becomes a matter of engineering design choice because of the effects which are brought to bear by the toroidal coil 50 windings.

The geometry of the toroid 40 tends to create a condition which is very natural to the confinement of a magnetic field. This property may be exploited by running the flux 80 density up close to saturation, which not only produces high torque in the rotor 46, but which also drives down the inductive reactance of the coil 50 windings in much the same way as experienced in a saturable reactor. One result of applying this concept may be the approach of the coil 50 windings to a pure resistive impedance as the flux 80 density approaches saturation, and an associated diminution of the coil 50 rise-time. Therefore, as impedance (Z) approaches resistance (R) in value, the time (t) will become very small, and allows switching speeds of a very high order indeed and will produce a substantially square wave current in the windings.

Such an arrangement also allows for reasonably constant torque at any current setting, with current (I) being limited mostly by the value of resistance (R), and a variable speed function which will support a wide range of angular speeds and high values of acceleration. Under such conditions, the shaft horsepower is substantially linear at a given value of current, with angular velocity being the independent variable. Thus, a graph of shaft horsepower versus RPM is expected to be almost linear in nature.

Although inductive reactance is greatly reduced by the use of controlled saturation of the back iron, it cannot be eliminated completely, especially when lighter torque settings are arranged. Accordingly, where there is inductance (L) and current (I), there will be stored energy (E) in keeping with the relationship E=½LI². Therefore, when coil 50 windings collapse their magnetic fields at the start of each Dead Zone 70, the stored field energy will be converted back into electrical energy in very short intervals of time, and provisions preferably exist to contend with this recaptured power, such as those described and referenced herein.

In various embodiments where electro-mechanical commutation is employed, the recapture feature (e.g., energy recapture 100, FIG. 1) may be handled by the active, switching brushes (e.g., 39), and their connections to the outside world via the slip-ring assemblies (e.g., 34, 33). However, in one embodiment of an electronically controlled motor of toroidal design, the recapture function 100 may be achieved by fly-back diodes supplied as part of the controller 90 circuitry. But, in both cases, the reclaimed energy may be stored in a separate capacitor bank, or other storage device, and may be used either for powering a load external to the motor proper, or actually fed back to the motor input circuit (e.g., 20) where it can be used to lessen the power demand from the main line supply.

As also shown in FIG. 1, embodiments of the controller 90 may also communicate with a recaptured energy system 100. The concepts of recapturing energy from the collapse of the magnetic flux 80 fields in each coil 50, has been previously disclosed in co-pending application Ser. No. 13/562,233, titled “Multi-Pole Switched Reluctance D.C. Motor with a Constant Air Gap and Recovery of Inductive Field Energy,” which is hereby incorporated by reference in its entirety.

In brief, each collapsing flux 80 field in coil 50 produces an electrical output pulse which represents the re-captured field energy. These pulses may be then directed by the controller 90 to a recaptured energy system 100, and then may be stored, for example, in a capacitor bank or other storage that comprises part of recapture system 100. In some embodiments, energy from this recapture system 100 could be removed if desired, and used to supply power to external appliances (not shown).

In some embodiments, recapture system 100 may operate in “Open System Operation,” which means that energy recaptured from the motor's inductive components during its operation, will be applied to a capacitive storage element, and then utilized to supply power to some electrical load external to the motor itself, such as a lamp, a resistor, a pump, etc. Of course, any suitable external load may be powered in this manner.

Likewise, power inverters or other devices can be used to convert the recaptured power to alternating current (AC). Unconverted direct current (DC) power from recapture system 100 may be used to power DC loads. Other configurations of Open System Operation are also possible.

In addition, some embodiments may be designed for “Closed System Operation,” which means that energy recaptured from the motor's inductive components during its operation, may be applied to a capacitive storage element in recapture system 100 and then utilized to send power back to the motor power supply by means of a DC to DC converter operating in conjunction with an electronic feedback controller, or the like. Other configurations of Closed System Operation are also possible.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. An electric toroid motor comprising:
a generally annular stator comprising:
a plurality of coils arranged around the periphery of the annular stator; and
a generally cylindrical opening, having a substantially uniform circumference, and located substantially in the center of the generally annular stator; and
a commutator that provides electrical switches to selectively connect a source of power to a predetermined number of the plurality of coils; and
a rotor comprising:
a magnetically permeable path from a first edge of the rotor to a second edge of the rotor; and
wherein the rotor is positioned to rotate within the generally cylindrical opening in the stator, and wherein the first edge and second edge of the rotor are spaced to define a substantially uniform gap from the circumference of the generally cylindrical opening in the stator.

2. The toroid motor of claim 1 further comprising:
a commutator driver in mechanical communication with the commutator and configured to provide a motive force that moves the commutator and enables the electrical switches to operate.

3. The toroid motor of claim 2 wherein the electrical switches further comprise:
at least one brush;
at least one contact; and
wherein the motive force that moves the commutator enables the at least one brush to selectively come into contact with the at least one contact and thereby electrically connect the brush and the contact.

4. The toroid motor of claim 1 wherein the commutator is located remotely from the generally annular stator.

5. The toroid motor of claim 1 wherein the rotor further comprises a shaft and wherein the shaft comprises an output coupler.

6. The toroid motor of claim 1 wherein the plurality of coils are electrically connected in series.

7. The toroid motor of claim 1 wherein the plurality of coils are electrically connected in parallel.

8. The toroid motor of claim 7 further comprising:
a controller in communication with the stator and configured to independently control the power cycles for the plurality of coils.

9. The toroid motor of claim 1 wherein the rotor further comprises:
an un-excited rotor formed of a magnetically permeable material and further comprising a generally rectangular shape with a curved first end corresponding to the first edge of the magnetically permeable path, and a curved second end corresponding to the second edge of the magnetically permeable path, and wherein the first and second ends are curved to conform to a curvature that generally matches the curvature of the circumference of the generally cylindrical opening in the stator.

10. The toroid motor of claim 1 wherein the rotor further comprises:
a substantially disc shaped rotor comprising a magnetically permeable path therethrough.

11. A method for generating a rotating magnetic field in a toroid motor comprising a commutator and stator with a plurality of coils connected in series, the method comprising:
selectively connecting a predetermined number of a first set of the plurality of coils to a first polarity power source;
selectively connecting a predetermined number of a second set of the plurality of coils to a second polarity power source;
selectively disconnecting and isolating a predetermined number of a third set of the plurality of coils from both of the first and second polarity power sources;
varying the selective connection and disconnection of the first, second, and third sets of the plurality of coils by rotation of the commutator, and thereby
creating a rotating magnetic flux field.

12. The method of claim 11 wherein the step of selectively disconnecting and isolating the predetermined number of the third set of the plurality of coils creates at least one Dead Zone of inactive coils.

13. The method of claim 11 wherein the toroid motor further comprises a rotor, and the step of selectively disconnecting and isolating the predetermined number of the third set of the plurality of coils creates at least two Dead Zones of inactive coils located substantially on opposite sides of the stator and wherein the at least two Dead Zones rotate substantially in synchronism with the rotor.

14. The method of claim 13 further comprising:
enabling magnetic flux from the magnetic flux field to pass from the stator through the Dead Zones and through the rotor.

15. The method of claim 12 further comprising recapturing stored field energy due to the collapsing magnetic field caused by the entry of a coil into at least one Dead Zone.

16. A method for generating a rotating magnetic field in a toroid motor comprising a commutator and stator with a plurality of coils connected in parallel, the method comprising:
selectively connecting a predetermined number of a first set of the plurality of coils to a first polarity power source;
selectively connecting a predetermined number of a second set of the plurality of coils to a second polarity power source;
selectively disconnecting and isolating a predetermined number of a third set of the plurality of coils from both of the first and second polarity power sources;
varying the selective connection and disconnection of the first, second, and third sets of the plurality of coils by electronic control of the commutator, and thereby
creating a rotating magnetic flux field.

17. The method of claim 16 wherein the step of selectively isolating disconnecting the predetermined number of the third set of the plurality of coils creates at least one Dead Zone of inactive coils.

18. The method of claim 16 wherein the toroid motor further comprises a rotor, and the step of selectively disconnecting the predetermined number of the third set of the plurality of coils creates at least two Dead Zones of inactive coils located substantially on opposite sides of the stator and wherein the at least two Dead Zones rotate substantially in synchronism with the rotor.

19. The method of claim 18 further comprising:
enabling magnetic flux from the magnetic flux field to pass from the stator through the Dead Zones and through the rotor.

20. The method of claim 17 further comprising recapturing stored field energy due to the collapsing magnetic field caused by the creation of the at least one Dead Zone.

21. A method for creating a substantially constant torque output for a given input current for a toroid motor comprising a stator with a plurality of coils, a rotor, and a commutator, the method comprising:
selectively connecting the input current to a predetermined number of a first set of the plurality of coils;
selectively connecting the input current to a a predetermined number of a second set of the plurality of coils;
selectively disconnecting and isolating the input current from a predetermined number of a third set of the plurality of coils;
varying the selective connection and disconnection of the first, second, and third sets of the plurality of coils by application of the commutator, and thereby creating at least two Dead Zones of inactive coils located substantially on opposite sides of the stator and wherein the at least two Dead Zones rotate substantially in synchronism with the rotor and cause the rotor to create a substantially constant torque output.

22. The method of claim 21 wherein the substantially constant torque output is independent of the rotor speed.

23. The method of claim 21 wherein the current developed in the coils comprises a substantially constant square wave input current that remains a square wave during on time regardless of polarity.

24. A method for creating two opposing magnetic fields for a toroid motor comprising a stator with a plurality of coils, a rotor, and a controller, the method comprising:
controlling the connecting of the input current to a predetermined number of a first set of the plurality of coils;
controlling the connecting of the input current to a predetermined number of a second set of the plurality of coils;
controlling the disconnecting and isolation of the input current from a predetermined number of a third set of the plurality of coils;
varying the controlled connection and disconnection of the first, second, and third sets of the plurality of coils by a predetermined timing sequence, and thereby creating at least two Dead Zones of inactive and isolated coils located substantially on opposite sides of the stator and wherein the at least two Dead Zones rotate substantially in synchronism with the rotor and enable the creation of two opposing magnetic fields.
